(19) United States
(12) Patent Application Publication
(10) Pub. No.: US 2008/0146327 A1
(43) Pub. Date: Jun. 19, 2008

(54) Gaming machine with prize building feature

(75) Inventor: Colin Fong, Lane Cove NSW (AU)

Correspondence Address: MCANDREWS HELD & MALLOY, LTD, 500 WEST MADISON STREET, SUITE 3400, CHICAGO, IL, 60661, US

(73) Assignee: Aristocrat Technologies Australia Pty Ltd, Lane Cove NSW (AU)

(21) Appl. No.: 11/953,613

(22) Filed: Dec. 10, 2007

Related U.S. Application Data
(63) Continuation of application No. 10/793,453, filed on Mar. 3, 2004, now abandoned.

(30) Foreign Application Priority Data
Mar. 7, 2003 (AU) 2003901034

(51) Int. Cl. A63F 13/00

(52) U.S. Cl. 463/27

(57) ABSTRACT

A gaming machine and a method of operating a gaming machine is disclosed. A game controller of the gaming machine includes a bonus feature in which meters having a plurality of number positions are selected and displayed on the display. By a selection process, a number from a set of numbers is selected and associated with at least one number position of the meters. Completion of filling of the number positions of at least one meter provides an indication of a prize won by a player and the gaming machine awards the indicated prize or a prize related to the indicated prize.

### FIELD OF THE INVENTION

This invention relates to a gaming machine. More particularly, the invention relates to a gaming machine and to an improvement to a game played on such a gaming machine.

### BACKGROUND TO THE INVENTION

Players who regularly play gaming machines quickly tire of particular games and therefore it is necessary for manufacturers of these machines to develop innovative game features which add interest to the games. In so doing, it is hoped to keep players amused and therefore willing to continue playing the game as well as to attract new players.

Also, with the growth that has occurred in the gaming machine market, there is intense competition between manufacturers to supply various existing and new venues. When selecting a supplier of gaming machines, the operator of a venue will often pay close attention to the popularity of various games with their patrons. Therefore, gaming machine manufacturers are keen to devise games and/or game features which are popular with the players as a mechanism for improving sales, retaining customers and attracting new customers.

### SUMMARY OF THE INVENTION

According to a first aspect of the invention, there is provided a gaming machine having a display and a game controller arranged to control images of symbols displayed on the display, the game controller being arranged to play a game wherein at least one random event is caused to be displayed on the display means and, if a predefined winning event occurs, the machine awards a prize, wherein the game comprises a bonus feature in which at least one meter, having a plurality of number positions, is displayed on the display and, by a predetermined selection process, a number from a set of numbers is selected and associated with at least one number position of the at least one meter, a decision as to which number position of the at least one meter is to be filled by which of the numbers from the set being made by the game controller, and completion of filling of the number positions of the at least one meter providing an indication of a prize won by a player.

According to a second aspect of the invention, there is provided a game to be played on a gaming apparatus, the gaming apparatus having a display and being controlled by a game controller arranged to control images displayed on the display, the game comprising a bonus feature in which at least one meter, having a plurality of number positions, is displayed on the display and, by a predetermined selection process, a number from a set of numbers is selected and associated with at least one number position of the at least one meter, a decision as to which number position of the at least one meter is to be filled by which of the numbers from the set being made by the game controller, and completion of filling of the number positions of the at least one meter providing an indication of a prize won by a player.

A gaming apparatus is to be understood to include apparatus that does not require the wagering of a stake in order to play the game and further includes apparatus which is connectable to a network.

In a first embodiment of the invention, the meter may comprises a plurality of sub-meters. The sub-meters constituting the meter may have the same amount of number positions as one another or, instead, the sub-meters constituting the meter may have different amounts of number positions.

Further, in this embodiment of the invention, when a number is selected, the selected number may be associated with a number position of more than one sub-meter. In one version of this embodiment of the invention, the selected number may be associated with the relevant number position/s of the sub-meter/s by being inserted into the number position/s of the sub-meter/s.

The sub-meters may be displayed on the display together with the set of numbers. The set of numbers may be from zero to nine or a subset thereof.

In this version of the first embodiment of the invention, the numbers may be visible to the player, the player may select one of the numbers and if that number corresponds to a number, which is not visible and which has been previously chosen by the game controller, at a number position of any of the sub-meters, that number may be inserted into the, or each, number position. When a number has been selected by the player, that number may be removed from the set of numbers so that it cannot be re-selected.

The selection procedure by the player may continue until all the number positions of at least one of the sub-meters of the meter have been completed. It will be appreciated that it is possible for the number positions of more than one sub-meter to be completed simultaneously especially where the sub-meters are of differing number position lengths.

In a second version of this embodiment of the invention, the set of numbers may be arranged, in an initial phase, in a hidden fashion in a number list on the display and each time the bonus feature is awarded, a plurality of sub-meters may be displayed on the display with the number positions of each of the sub-meters being filled by numbers selected by the controller, the numbers appearing in the number positions of the sub-meters in the initial phase being in a non-highlighted configuration.

Each time the player selects a position in the number list, the number at the position may be revealed and, if that number corresponds to a non-highlighted number at any position in the sub-meters, the or each occurrence of the non-highlighted number is changed to a highlighted configuration. In this embodiment, by “highlighted” is meant that the number is in some way differentiated from a non-selected number, for example, by being made brighter than the other numbers, changing to a different colour, changing to a different font, or the like.

Once again, the selection of numbers from the number list by the player may continue until all the number positions of at least one of the sub-meters of the meter have been highlighted.

The prize awarded to the player may be the total amount shown on the, or each, completed sub-meter of the meter, multiplied by a wager of the triggering base game.

In a third embodiment of the invention, a plurality of sets of numbers may be provided and the game controller may randomly select one of the sets of numbers. Each set of numbers may be from zero to nine or a subset of the series of numbers from zero to nine.

To provide an interesting appearance to the feature, the selected set of numbers may be perceived to be in a receptacle. The receptacle may be transparent The receptacle may be “shaken” or otherwise manipulated so that the appearance of selecting one of the numbers is imparted to the player. Instead, the receptacle may be opaque and the selected set of numbers may be displayed alongside or above the receptacle. As a number is dispensed from the receptacle, it is removed from the displayed set of numbers.

In this embodiment of the invention, a single meter may be provided comprising at least three number positions.

The selection of the numbers may be made by the game controller and, once the game controller has selected a number, the selected number is placed in one of the number positions in the meter. In addition, the selection of the number position in which the number is to be placed may be made by the game controller. In this embodiment of the invention, the selected numbers may be placed in the meter from the right number position to the left number position, consecutively.

When a number has been selected by the game controller from the receptacle, it may, in effect, be removed from the receptacle so that it cannot be re-selected.

Regardless of the embodiment of the invention, the player may have to wager an additional stake in order to be eligible for the bonus feature. The bonus feature may be triggered randomly. When the bonus feature is triggered, a number of bonus features may be offered to the player, two of which may be the embodiments of the bonus feature of the invention, as described above. Instead of the additional stake, the bonus feature may be triggered by the occurrence of a trigger condition without the wagering of an additional stake. For example, the bonus feature may be triggered by the occurrence of a predetermined combination of symbols in a base game. The predetermined combination of symbols may be a predetermined number of scatter symbols in the base game.

According to a third aspect of the invention, there is provided a method of operating a gaming machine having a display and a game controller arranged to control images displayed on the display, the game controller being arranged to play a game wherein at least one random event is caused to be displayed on the display means and, if a predefined winning event occurs, the machine awards a prize, the method comprising

in a bonus feature associated with the game displaying at least one meter, having a plurality of number positions; and,

by a predetermined selection process, selecting a number from a set of numbers and associating the selected number with at least one number position of the at least one meter, a decision as to which number position of the at least one meter is to be filled by which of the numbers from the set being made by the game controller, and completion of filling of the number positions of the at least one meter providing an indication of a prize won by a player.

In one embodiment of the invention, the method may include implementing the meter as a plurality of sub-meters. The method may include, when a number is selected, associating the selected number with a number position of more than one sub-meter. Further, the method may include displaying the sub-meters on the display together with the set of numbers.

In one version of the first embodiment, the method may include rendering the numbers visible to the player, causing the player to select one of the numbers and if that number corresponds to a number, which is not visible and which has been previously chosen by the game controller, at a number position of any of the sub-meters, inserting that number into the, or each, number position.

The method may include continuing with the selection procedure until all the number positions of at least one of the sub-meters of the meter have been completed.

In another version of the first embodiment, the method may include arranging the set of numbers, in an initial phase, in a hidden fashion in a number list on the display and each time the bonus feature is awarded, displaying a plurality of sub-meters with the number positions of each of the sub-meters being filled by numbers selected by the controller, the numbers appearing in the number positions of the sub-meters in the initial phase being in a non-highlighted configuration.

The method may include, each time the player selects a position in the number list, revealing the number at the position and, if that number corresponds to a non-highlighted number at any number position in the sub-meters, changing the non-highlighted number to a highlighted configuration.

The method may include continuing with the selection of numbers from the number list until all the number positions of at least one of the sub-meters of the meter have been highlighted.

Further, the method may include awarding as the prize the total amount shown on the, or each, completed sub-meter of the meter, multiplied by a wager of the triggering base game.

In another embodiment of the invention, the method may include providing a plurality of sets of numbers and randomly selecting one of the sets of numbers.

Then, the method may include providing a single meter comprising at least three number positions.

The method may include causing the game controller to select the numbers and, once the game controller has selected a number, placing the selected number in one of the number positions in the meter. Further, the method may include causing the game controller to select the number position in which the number is to be placed.

The player may have to wager an additional stake in order to be eligible for the bonus feature.

### BRIEF DESCRIPTION OF THE DRAWINGS

The invention is now described by way of example with reference to the accompanying diagrammatic drawings in which:

FIG. 1 shows a perspective view of a gaming machine, in accordance with the invention;

FIG. 2 shows a block diagram of a control circuit of the gaming machine;

FIG. 3 shows a screen display of a first version of a first embodiment of a bonus feature of a game played on the gaming machine of FIG. 1;

FIGS. 4-8 show screen displays of various stages in the playing of the first version of the first embodiment of the bonus feature;

FIG. 9 shows a modification to the first version of the first embodiment of the bonus feature;

FIG. 10 shows an initial screen display of a second embodiment of a bonus feature of a game played on the gaming machine of FIG. 1;

FIGS. 11-13 show screen displays of various stages in the playing of the second embodiment of the bonus feature; and

FIGS. 14-17 show screen displays of various stages in the playing of a second version of the first embodiment of the bonus feature.

### DETAILED DESCRIPTION OF THE DRAWINGS

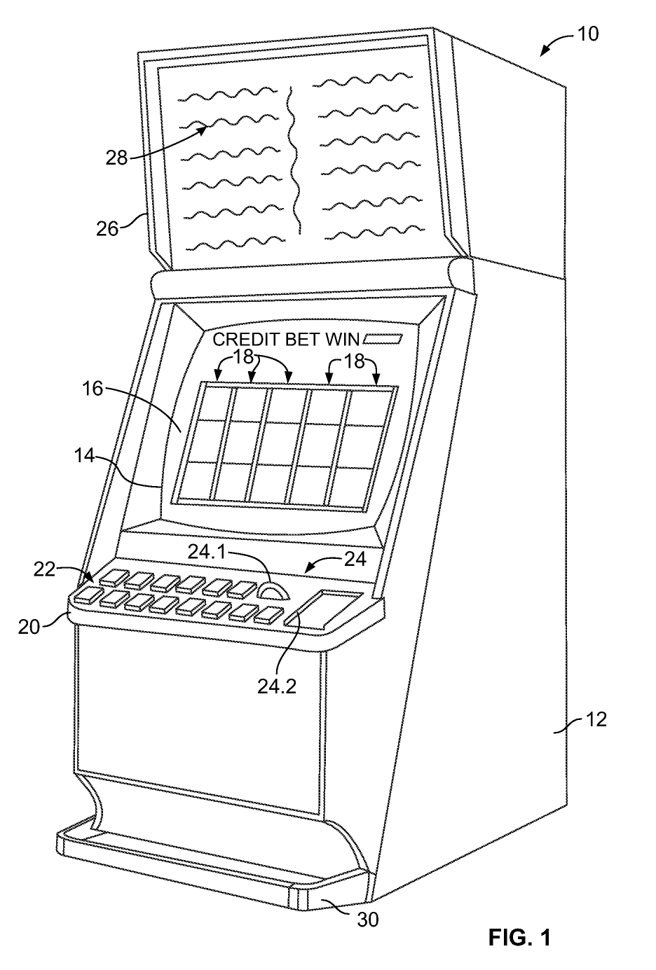

In FIG. 1, reference numeral 10 generally designates a gaming machine, including a game, in accordance with the invention. The machine 10 includes a console 12 having a display means in the form of a video display unit 14 on which a game 16 is played, in use. The video display unit 14 may be implemented as a cathode ray screen device, a liquid crystal display, a plasma screen, or the like. The game 16 has a base game which is a spinning reel game that simulates the rotation of a number of spinning reels 18. A midtrim 20 of the machine 10 houses a keypad 22 for enabling a player to play the game 16. The midtrim 20 also houses a credit input mechanism 24 including a coin input chute 24.1 and a bill collector 24.2.

The machine 10 includes a top box 26 on which artwork 28 is carried. The artwork 28 includes paytables, details of bonus awards, etc.

A coin tray 30 is mounted beneath the console 12 for cash payouts from the machine 10.

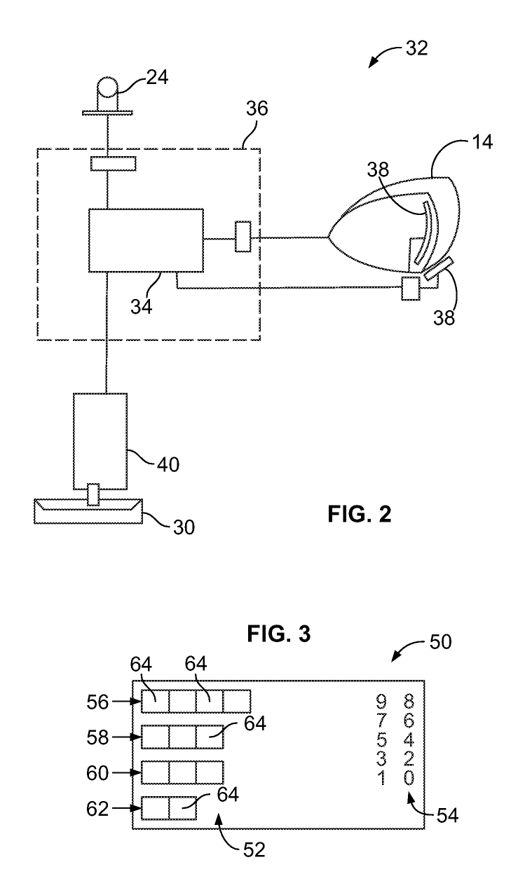

Referring to FIG. 2 of the drawings, a control means or control circuit 32 is illustrated. A program which implements the game and user interface is run on a processor 34 of the control circuit 32. The processor 34 forms part of a controller 36 that drives the screen of the video display unit 14 and that receives input signals from sensors 38. The sensors 38 include sensors associated with the bank 22 of buttons and touch sensors mounted in the screen of the video display unit 14. The controller 36 also receives input pulses from the mechanism 24 to determine whether or not a player has provided sufficient credit to commence playing. The mechanism 24 may, instead of the coin input chute 24.1 or the bill collector 24.2, or in addition thereto, be a credit card reader (not shown) or any other type of validation device.

Finally, the controller 36 drives a payout mechanism 40 which, for example, may be a coin hopper for feeding coins to the coin tray 30 to make a pay out to a player when the player wishes to redeem his or her credit.

The game 16, in accordance with the invention, includes a bonus feature that follows the base game. To be eligible for the bonus feature, the player may have to wager an additional stake, for example, an additional 5 credits over and above the number of credits bet per line and the number of lines bet. Instead, the bonus feature may be a no-cost feature and may be triggered by other triggering conditions. For example, the occurrence of a combination of scatter symbols in the underlying base game of the game 16 may trigger the bonus feature, the bonus feature may be triggered randomly, by a central controller, or the like.

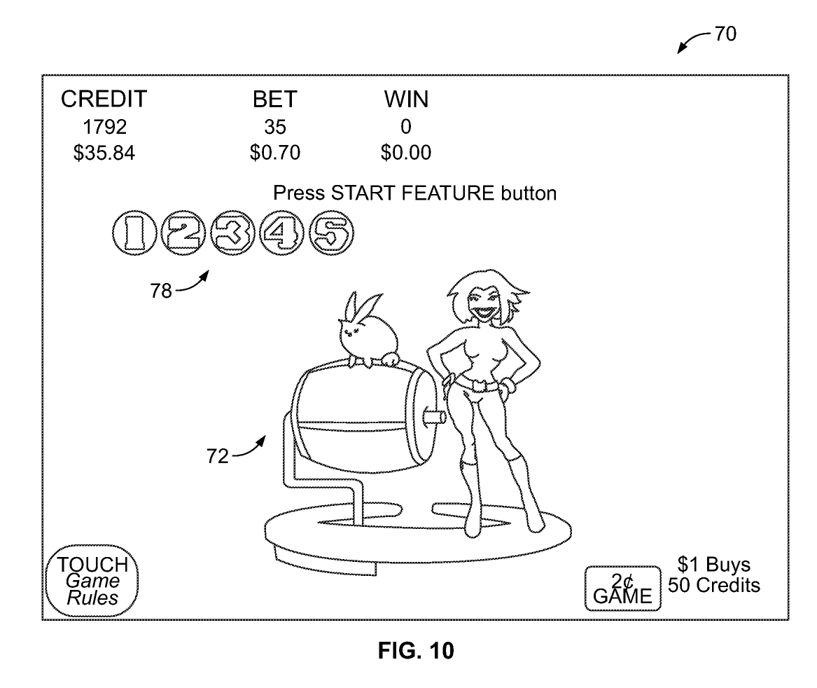

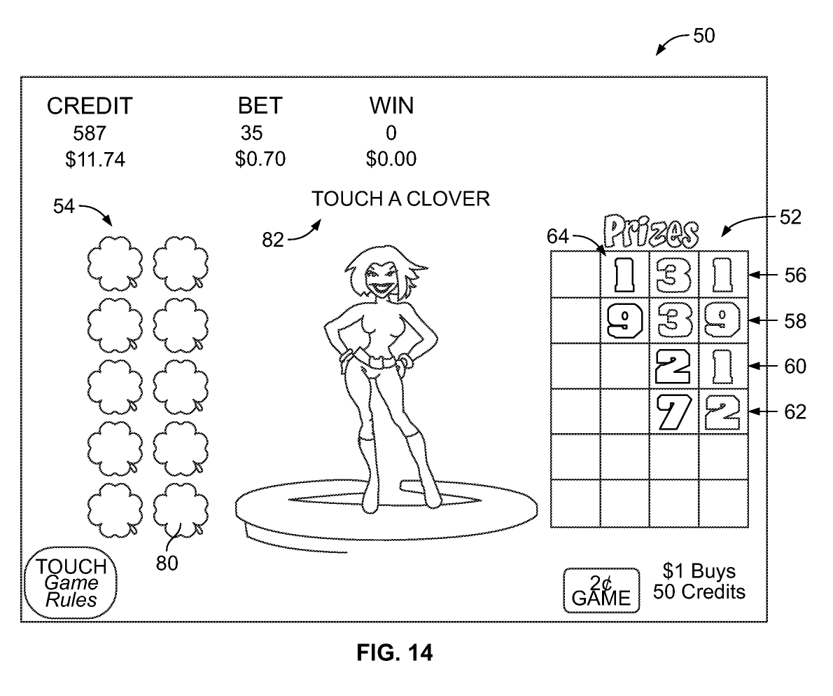

Regardless of how the bonus feature is triggered, when the bonus feature is awarded, the player may be offered a plurality of bonus features two of which are in accordance with the invention and which are described below with reference firstly to FIGS. 3-9 of the drawings and FIGS. 14-17 of the drawings and, secondly, with reference to FIGS. 10-13 of the drawings.

Referring to FIGS. 3-9, a first version of a first embodiment of the bonus feature, in accordance with the invention is described. When the bonus feature is awarded and selected by the player, an initial screen display 50 is displayed on the screen of the video display unit 14. The screen display 50 displays a meter 52 and a set of numbers 54. The meter 52 comprises a plurality of sub-meters 56, 58, 60 and 62, each of which has a plurality of number positions 64. Initially, all the number positions 64 for each of the sub-meters 56-62 are blank.

The set of numbers 54 is arranged behind a touch-sensitive membrane on the screen of the VDU 14. The player is offered the opportunity of selecting any one of the numbers in the set of numbers 54 by touching the selected number of the set 54 on the screen of the VDU 14.

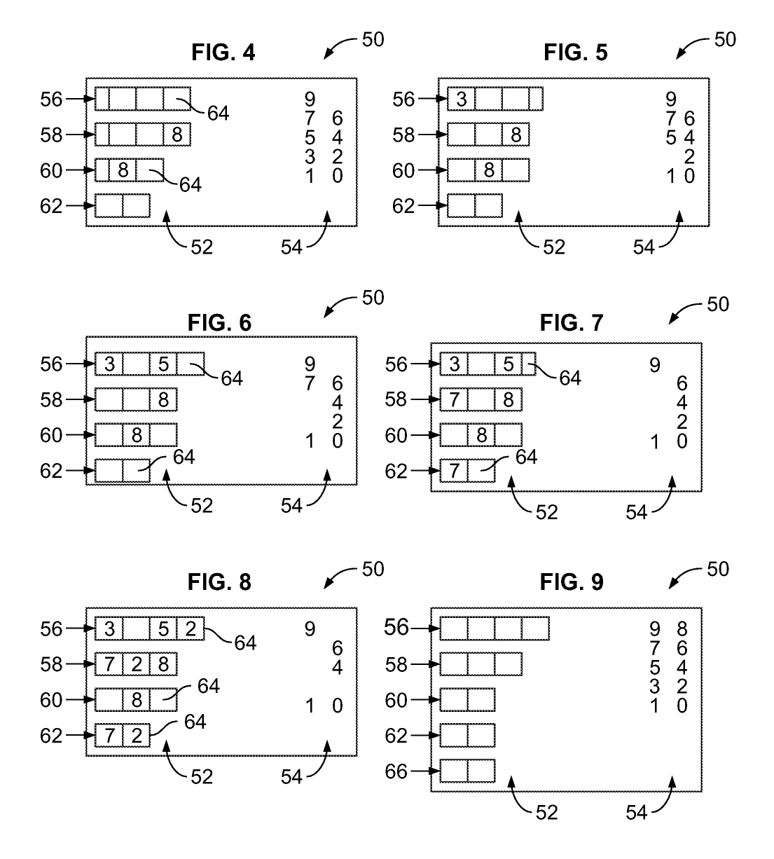

As shown in FIG. 4 of the drawings, the player initially selects number “8”. The controller 34 has predetermined which number positions 64 of the sub-meters 56-62 contain which numbers. There are two occurrences of the number “8”, one in sub-meter 58 and the other in sub-meter 60. Once a number has been selected by the player from the set of numbers 54, it is removed from the set 54.

The player then selects the number “3” from the set of numbers 54. Only a single occurrence of the number “3” has been preselected by the controller 34 to occur in the meter 52 being in sub-meter 56. That position in sub-meter 56 is filled by the number “3” as illustrated in FIG. 5 of the drawings.

As shown in FIG. 6 of the drawings, the following selection made by the player is the number “5”. Once again, there is only a single occurrence of a number position 64 having the number “5”. That position 64 is, once again, in the sub-meter 56 of the meter 52 and is filled by the number 5.

With reference to FIG. 7 of the drawings, the player then selects number “7” from the set of numbers 54 by touching the screen of the VDU 14. There are two occurrences of number positions 64 having the number “7” associated with them, being in sub-meters 58 and 62 and these positions 64 are each filled with the number “7”.

Finally, the player selects the number “2” from the set of numbers 54. There are three occurrences of number positions 64 of the meter 52 having the number “2” associated with them. The number “2” is therefore inserted into these number positions 64 of the meter 52 as shown in FIG. 8 of the drawings.

As two of the sub-meters, 58 and 62 have had all their number positions 64 filled, the bonus feature is regarded as concluded and the player is awarded a bonus prize being the sum of the amounts in the sub-meters 58 and 62. Thus, in the example illustrated, the player is awarded a bonus prize of 800 credits.

FIG. 9 shows another example of the first variation of the first embodiment of the invention. Whereas the meter 52 in the example shown in FIGS. 3-8 had four sub-meters, the meter 52 in the example shown in FIG. 9 of the drawings has five sub-meters 56, 58, 60, 62 and 66.

It is to be noted that the controller 34 contains a set of meters 52, each meter 52 in the set having different sub-meters, with some of the sub-meters being different in size from other sub-meters, and different numbers of sub-meters. When the bonus feature is triggered, one of the meters 52 is randomly selected by the controller 34. Each number position 64 of each of the sub-meters is allocated a number from the range of numbers, 0 to 9, but the numbers allocated to the number positions 64 of the sub-meters of the selected meter 52 are not revealed to the player.

Once the bonus prize has been awarded, the controller 34 may reveal to the player what numbers were in the remaining number positions 64 which had not been filled. The remaining numbers could be shown in a different colour or shaded differently to differentiate between those and the numbers which had been selected by the player.

Referring now to FIGS. 14-17 of the drawings, a second version of the first embodiment of the invention is illustrated. With reference to FIGS. 3 to 9 of the drawings, like reference numerals refer to like parts, unless otherwise specified.

In this embodiment of the invention, the number list 54 has its numbers hidden behind concealing elements 80. In keeping with the theme of the bonus feature, the concealing elements 80 are elements which represent luck such as, for example, a four leaf clover.

In the example illustrated, the meter 52 comprises four sub-meters 56, 58, 60 and 62. The sub-meters 56 and 58 have three number positions 64 which are active and the sub-meters 60 and 62 have two number positions 64 which are active. It will be noted from the display 50 that the meter 52 could comprise up to six sub-meters, each of which has four number positions 64 associated with them.

Upon commencement of the bonus feature, the game controller 34 pre-selects the number of sub-meters constituting the meter 52 and the quantity of number positions 64 constituting each sub-meter. In addition, the game controller 34 inserts numbers selected from the set of numbers from 0 to 9 into the selected number position 64. All of the numbers allocated to the number positions 64 of the meter 52 are shown, at commencement of the bonus feature, in a non-highlighted manner.

A message 82 appears on the display 50 at the start of the bonus feature instructing the player to touch one of the four leaf clovers 80. As indicated above, the VDU 14 is covered by a touch-sensitive membrane and when the four leaf clover 80 is touched, it is removed to reveal a number beneath it.

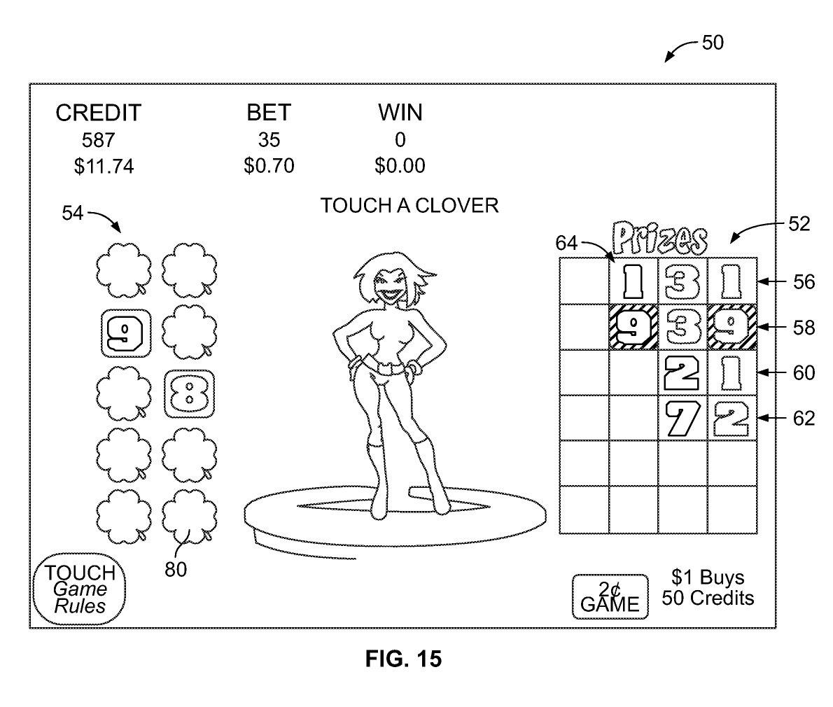

FIG. 15 shows the situation after the player has touched two of the four leaf clovers 80 covering the set of numbers 54. Assuming the four leaf clover 80 covering the number “8” was removed first, because the number 8 does not appear at any number position 64 in the meter 52, none of the numbers in the number positions 64 is highlighted.

After the second four leaf clover 80 has been removed by being touched, it reveals the number “9”. The sub-meter 58 has the number “9” at two number positions 64. Both of these number positions 64 are then changed into a highlighted configuration.

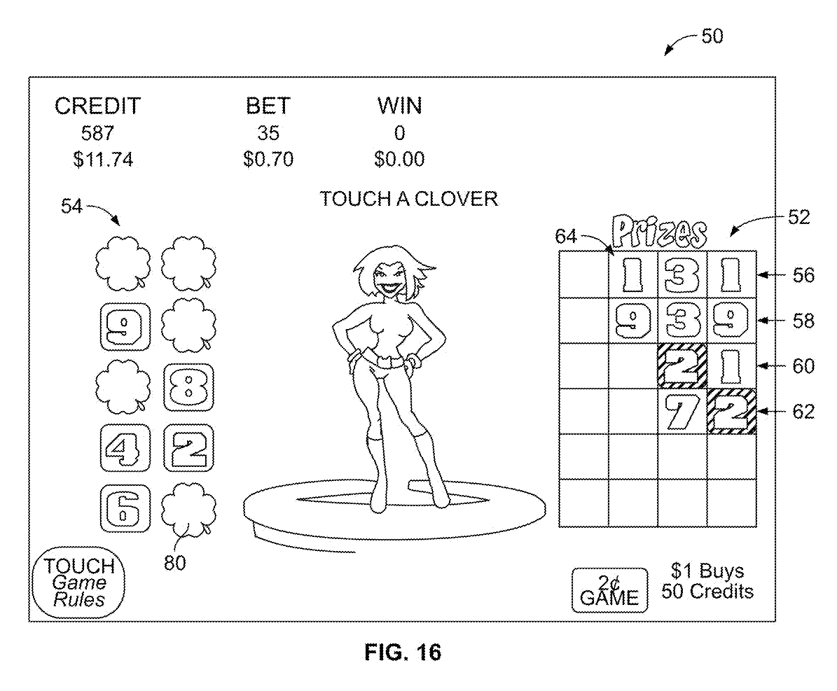

FIG. 16 shows the situation after three further four leaf clovers 80 have been touched. Of the numbers revealed, only the number “2” appears at number positions 64 in the sub-meters 60 and 62 of the meter 52. Once again, the numbers at these number positions 64 are changed to a highlighted configuration.

At this stage, because no sub-meter 56 has had all the numbers at its number positions 64 highlighted, the bonus feature continues.

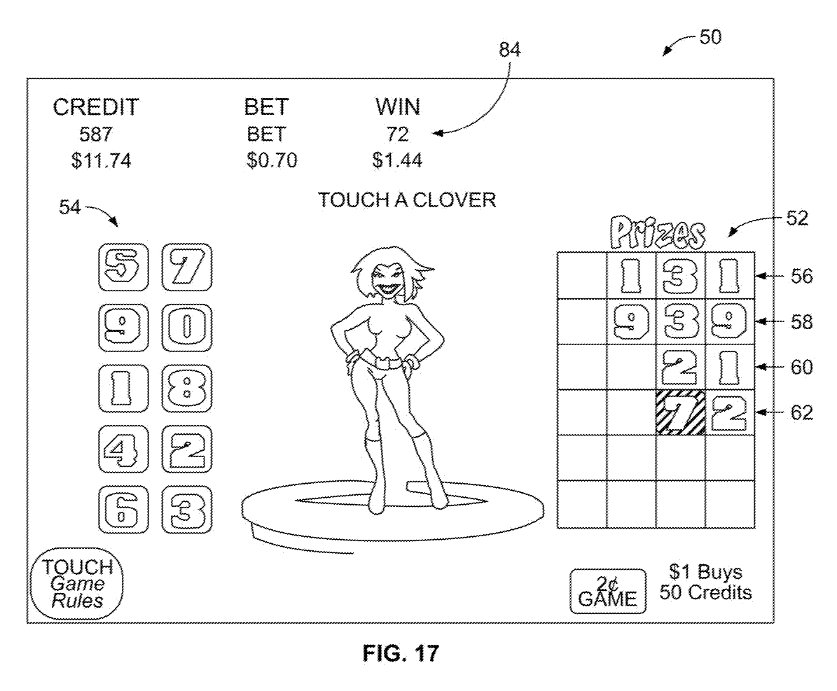

In a subsequent selection by the player (FIG. 17), the number “7” is revealed. This causes the number “7” at the first number position of the sub-meter 62 to be highlighted.

Because all the number positions of the sub-meter 62 have now been completed, the bonus feature is regarded as concluded. The player is awarded, as a prize, the number of credits reflected in the sub-meter 62. Thus, a win meter 84 on the display 50 is credited with 72 credits.

The remaining four leaf clovers 80 are then removed to reveal the positions of the remaining, non-selected numbers in the set of numbers 54. The non-selected numbers are shown in the set of numbers 54 in a way that distinguishes them from the numbers that had been revealed by the actions of the player, e.g. the non-selected numbers are shown in a non-highlighted fashion in the set of numbers 54. In this way, the player can readily determine which of the numbers were not selected.

Referring now to FIGS. 10-13 of the drawings, a second embodiment of the bonus feature is described. In this embodiment of the invention, a screen display 70 is displayed on the screen of the VDU 14 when the bonus feature is triggered. The screen display 70 initially shows a receptacle 72 which is a representation of an opaque barrel which, in use, is animated to rotate to select a number from a set of numbers contained in the barrel 72. Numbers corresponding to the numbers contained in the barrel 72 are displayed at 78 above the barrel 72.

When the bonus feature is triggered, the controller 34 selects one of a plurality of sets of numbers. For example, the controller 34 could contain the following sets of numbers:
1. Numbers 0,1,2,3,4.
2. Numbers 0,1,2,3,4,5,6,7,8,9.
3. Numbers 1,2,3,4,5.
4. Numbers 5,6,7,8,9.
5. Numbers 1,2,3,4,5,6,7,8,9.

It is assumed, in this case, that the third set of numbers has been selected by the game controller 34. It is to be noted that the selection of a set of numbers occurs randomly. As indicated above, the selected set of numbers is displayed at 78 above the barrel 72 as shown in FIG. 10 of the drawings. An initial animation (not shown) may show the numbers from the selected set of numbers being placed in the barrel 72. At this stage, no meter is visible in the display 70.

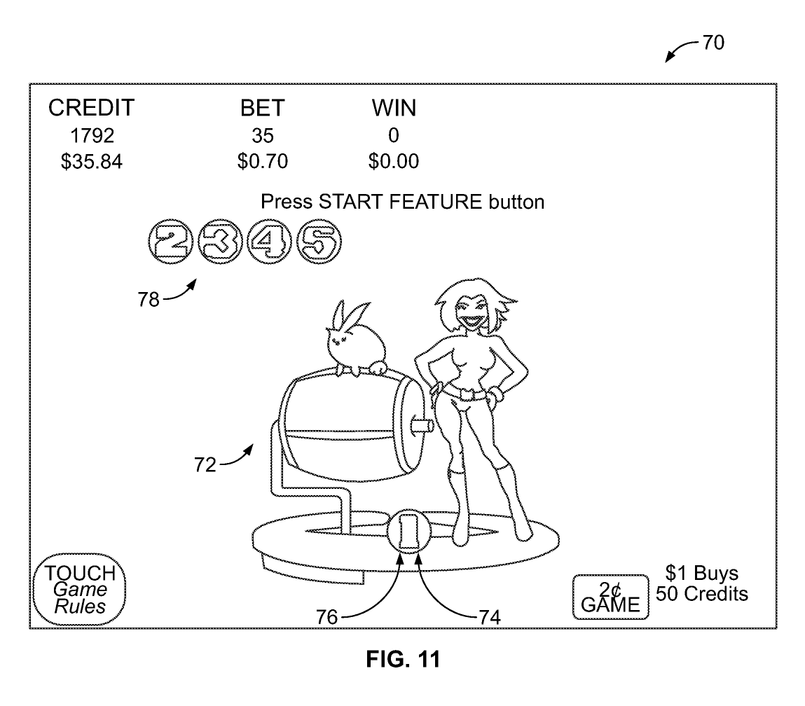

An animation occurs of the barrel 72 being rotated, shaken or being otherwise manipulated until a number “drops” from the barrel 72. In FIG. 11 of the drawings, the first number to drop from the barrel 72 is the number “1” which is placed in a first number position 76 of a meter 74.

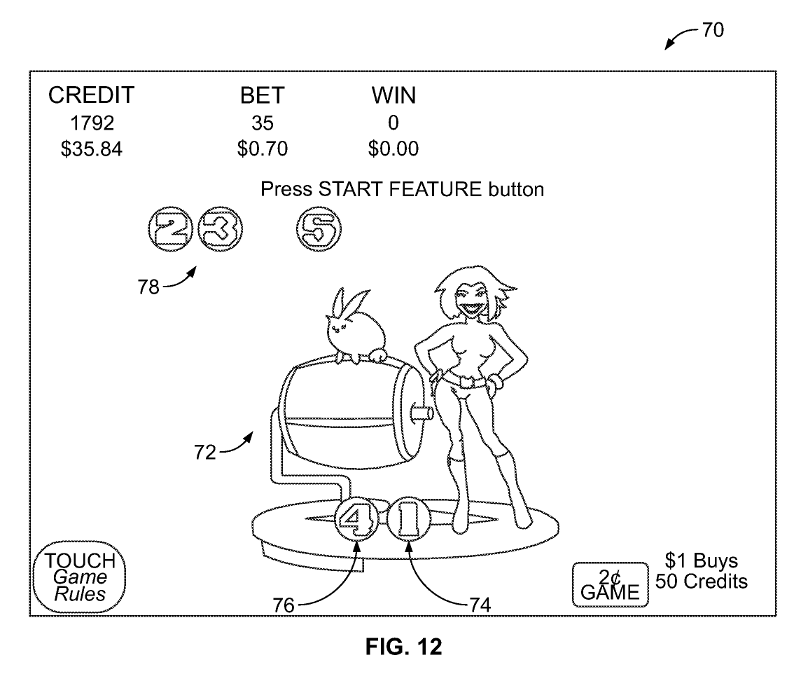

The barrel 72 is then again shaken, rotated or otherwise manipulated until the following number is ejected from the barrel 72. As shown in FIG. 12 of the drawings, the following number is the number “4” which is placed in the middle number position 76 of the meter 74.

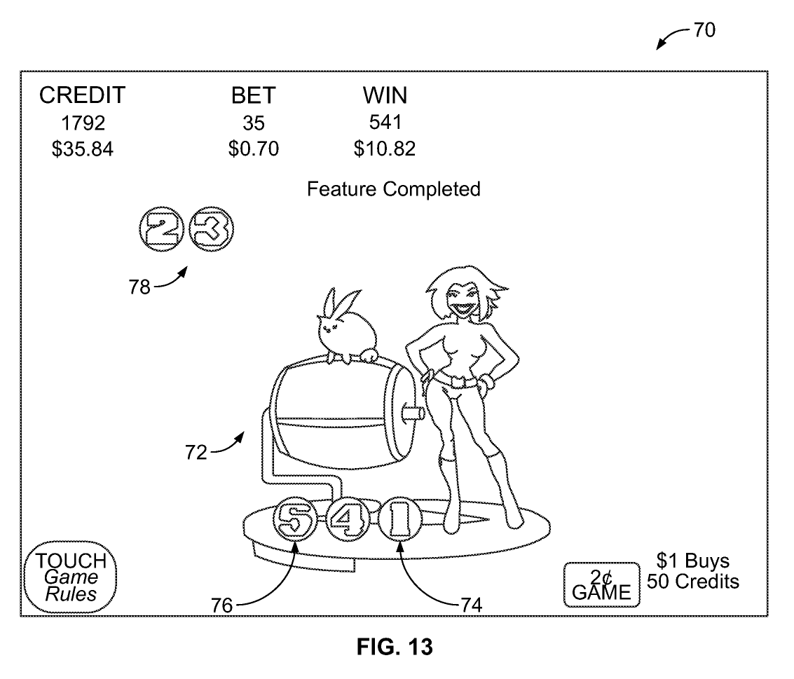

Finally, the number “5” is ejected from the barrel 72 and is placed in a third number position 76 of the meter 74 as shown in FIG. 13 of the drawings. The player is accordingly awarded a prize of 541 credits.

In a variation of this embodiment (not shown), instead of the barrel 72 being opaque with the set of numbers arranged above the barrel 72, the barrel 72 is transparent with the selected set of numbers being displayed in the barrel 72. In both cases, as a number is selected from the set, it is removed from the displayed set of numbers.

Hence, it is an advantage of the invention that a bonus feature is provided which, in an attractive and entertaining manner, awards a bonus prize to a player. The bonus features comprise various sets of numbers and various sets of meters so that the chance of players becoming familiar with the bonus features and, in so doing losing interest or being in a position to influence an outcome, is reduced.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A gaming machine having a display and a game controller arranged to control images of symbols displayed on the display, the game controller being arranged to play a game comprising a base game in which at least one random event is caused to be displayed on the display and, if a predefined winning event occurs, the gaming machine awards a prize, a player of the gaming machine having staked a wager on each play of the base game, wherein the game also comprises a bonus feature that is triggered during play of the base game and in which:
the game controller in a random selection process makes a selection of a plurality of meters, each meter comprising a plurality of number positions that are associated with a number wherein the random selection process results in different instances of the bonus game having a different number of selected meters and selected meters with different numbers of number positions;
each selected meter is displayed on the display;
numbers from a set of numbers are selected and if a said selected number matches a number associated with a number position of one or more of the selected meters, then the game controller determines that number position as being filled; and
when all of the number positions of at least one of the selected meters have been filled, the game controller causes the gaming machine to award a prize, wherein the awarded prize is dependent on a value indicated by the at least one meter that has been filled.

2. The gaming machine of claim 1 wherein the numbers that are associated with the number positions of the meter are initially not displayed on the display and the set of numbers are displayed on the display, and wherein the process of selecting numbers from the set of numbers is completed by the player selecting one of the numbers from the set of numbers and the gaming machine continues to receive from the player until all the number positions of at least one of the meters has been filled, wherein if all of the number positions of two or more meters are filled as a result of a selection from the set of numbers by the player, the prize awarded by the gaming machine is dependent on the sum of the values indicated by the two or more meters.

3. The gaming machine of claim 1 wherein the awarded prize is a value shown on the, or each, completed meter, multiplied by the wager that was staked in the play of the base game that resulted in the triggering of the bonus game.

4. The gaming machine of claim 1 in which a plurality of sets of numbers is provided and the game controller randomly selects one of the sets of numbers.

5. The gaming machine of claim 1 in which the selection of the numbers is made by the game controller and, once the game controller has selected a number, the selected number is placed in one of the number positions in the meter.

6. The gaming machine of claim 5 in which the selection of the number position in which the number is to be placed is made by the game controller.

7. The gaming machine of claim 1, including in memory a definition of a plurality of sets of meters, wherein at least two of the sets of meters comprise a different number of meters and meters with a different number of number positions, wherein when the game controller in a random selection process makes a selection of a plurality of meters, the game controller selects one of the sets of meters.

8. A method of operating a gaming machine having a display and a game controller arranged to control images displayed on the display, the game controller being arranged to play a game wherein at least one random event is caused to be displayed on the display and, if a predefined winning event occurs, the machine awards a prize, the method comprising:
in a bonus feature of the game selecting and displaying a plurality of meters, each meter comprising a plurality of number positions each associated with a number, wherein the plurality of meters are selected by a game controller of the gaming machine in a random selection process so that is different instances of the bonus feature a different number of meters are displayed and the meters have a different number of number positions;
by a selection process, selecting a number from a set of numbers and associating the selected number with at least one number position of the at least one meter so as to fill that number position;
repeating the selection process until at least one of selected meters has been completed by the filling of all of the number positions of that meter;
awarding a prize, the value of which is determined dependent on the value indicated by, the at least one completed meter.

9. The method of claim 8 which includes awarding the indicated prize multiplied by a wager of the game.

10. The method of claim 8 which includes providing a plurality of sets of numbers and randomly selecting one of the sets of numbers.

11. The method of claim 8 wherein selecting a number from the set of numbers includes the game controller selecting the numbers.

12. A gaming machine including a game controller that provides a game in which a plurality of symbols are selected are presented on a display and if a winning combination occurs, the gaming machine awards an award, wherein the gaming machine comprises a memory in which a definition of a plurality of sets of single digit numbers are stored, at least one of the sets of numbers having less then all of the digits 0 to 9 and at least two different sets of numbers having a different number of members, wherein the game controller provides a feature game on occurrence of a trigger event during play of the game by:
selecting one of the sets of numbers in a random selection process;
displaying the selected set of numbers on the display;
displaying a meter having a plurality of number positions, wherein the number of number positions is independent of the number of digits in the selected set of numbers;
randomly selecting individual numbers from the selected set of numbers and populating the number positions of the meter with the selected individual numbers;
determining when all the number positions of the meter have been populated; and
awarding a prize dependent on a value indicated by the fully populated meter.
